(19) United States
(12) Patent Application Publication
(10) Pub. No.: US 2026/0129262 A1
(43) Pub. Date: May 7, 2026

(54) RECOMMENDATIONS BASED ON EMBEDDED MODELS ON A TELEVISION

(71) Applicant: GOOGLE LLC, Mountain View, CA (US)

(72) Inventors: Sundaramoorthy Murugesan, Bangalore (IN); Tamojit Chatterjee, Shyamnagar (IN); Shravan Nayak, Bangalore (IN); Kopal Niranjan, Lucknow (IN); Priyanshi Sharma, Greater Noida (IN); Sujal Maheswari, Bhilwara (IN); Kanishka Mishra, Bangalore (IN)

(21) Appl. No.: 18/936,055

(22) Filed: Nov. 4, 2024

(51) Int. Cl. H04N 21/466; H04N 21/442; H04N 21/45

(52) U.S. Cl. CPC H04N 21/4668; H04N 21/44222; H04N 21/4532

(57) ABSTRACT

According to an aspect, a method may include executing, by a computing device, a television application. A method may include gathering, by the computing device, information and data related to interactions of a user with a user interface of the television application. A method may store the information and data related to the interactions of the user locally on the computing device. A method may generate an on-device model associated with the user based on the information and data related to the interactions of the user with the user interface of the television application. A method may determine media content recommendations for the user utilizing the on-device model. A method may integrate the media content recommendations in the user interface of the television application.

### BACKGROUND

A television (TV) application may present various types of media content of interest to a user. The media content may have different formats such as streaming video and audio. The types of media content may include, but are not limited to, movies, television shows, sporting events, news items, short form videos, and music. In addition, or in the alternative, a variety of media content providers may deliver various types of media content for viewing by the user. The TV application may deliver a customized viewing experience to a user that spans the diverse types of media content provided by the variety of media content providers.

### SUMMARY

In some non-limiting examples, a network-connected display device (e.g., a smart television (TV)) may execute a television (TV) application. The TV application may interface with an artificial intelligence (AI) module included on the network-connected display device. The TV application may use large language models (LLMs) embedded in the AI module to determine media content for recommending to a user of the network-connected display device. For example, the user may have an account with and/or is otherwise logged into the TV application running on the network-connected display device. The TV application may gather and/or store information and data related to the interactions of the user with the TV application for use in determining media content recommendations for the user. The TV application may provide the information and data to the AI module for training the LLMs. The interactions of the TV application with the AI module remain local to the network-connected display device as the obtained information and data related to the interactions of the user with the TV application are not sent, provided, or shared with computing devices outside of the network-connected display device.

In some aspects, the techniques described herein relate to a method including: executing, by a computing device, a television application; gathering, by the computing device, information and data related to interactions of a user with a user interface of the television application; storing the information and data related to the interactions of the user locally on the computing device; generating an on-device model associated with the user based on the information and data related to the interactions of the user with the user interface of the television application; determining media content recommendations for the user utilizing the on-device model; and integrating the media content recommendations in the user interface of the television application.

In some aspects, the techniques described herein relate to a method, wherein the on-device model is embedded on the computing device.

In some aspects, the techniques described herein relate to a method, wherein the on-device model is a large language model.

In some aspects, the techniques described herein relate to a method, wherein the information and data associated with the user is not shared with any other computing devices.

In some aspects, the techniques described herein relate to a method, wherein the information and data include activities and interactions of the user with the television application.

In some aspects, the techniques described herein relate to a method, wherein the activities and interactions include at least one of selections or clicks by the user, a watch history of the user, a location of the computing device, a language used by the user when interacting with the television application, and a language of media content items watched or consumed by the user.

In some aspects, the techniques described herein relate to a method, further including: receiving additional training data; and fine-tuning the on-device model based on the received additional training data.

In some aspects, the techniques described herein relate to a method, wherein the fine-tuning uses one of a supervised fine-tuning process or a low rank optimization process.

In some aspects, the techniques described herein relate to a method, herein the computing device is a network-connected display device.

In some aspects, the techniques described herein relate to a method, wherein the network-connected display device is a smart television.

In some aspects, the techniques described herein relate to a non-transitory computer-readable medium storing executable instructions that when executed by at least one processor of a network-connected display device cause the at least one processor to execute operations, the operations including: executing a television application; gathering information and data related to interactions of a user with a user interface of the television application; storing the information and data related to the interactions of the user locally on the network-connected display device; generating an on-device model associated with the user based on the information and data related to the interactions of the user with the user interface of the television application; determining media content recommendations for the user utilizing the on-device model; and integrating the media content recommendations in the user interface of the television application.

In some aspects, the techniques described herein relate to a non-transitory computer-readable medium, wherein the on-device model is embedded on the network-connected display device.

In some aspects, the techniques described herein relate to a non-transitory computer-readable medium, wherein the on-device model is a large language model.

In some aspects, the techniques described herein relate to a non-transitory computer-readable medium, wherein the information and data associated with the user is not shared with any other computing devices.

In some aspects, the techniques described herein relate to a non-transitory computer-readable medium, wherein the information and data include activities and interactions of the user with the television application.

In some aspects, the techniques described herein relate to a non-transitory computer-readable medium, wherein the operations further include: receiving additional training data; and fine-tuning the on-device model based on the received additional training data.

In some aspects, the techniques described herein relate to a non-transitory computer-readable medium, wherein the fine-tuning uses one of a supervised fine-tuning process or a low rank optimization process.

In some aspects, the techniques described herein relate to a system including: at least one processor; and a non-transitory computer-readable medium storing instructions that when executed by the at least one processor cause the system to: execute a television application; gather information and data related to interactions of a user with a user interface of the television application; store the information and data related to the interactions of the user locally on the system; generate an on-device model associated with the user based on the information and data related to the interactions of the user with the user interface of the television application; determine media content recommendations for the user utilizing the on-device model; and integrate the media content recommendations in a user interface of the television application.

In some aspects, the techniques described herein relate to a system, wherein the on-device model is embedded on the system.

In some aspects, the techniques described herein relate to a system, wherein the information and data associated with the user is not shared with any other systems.

The details of one or more implementations are set forth in the accompanying drawings and the description below. Other features will be apparent from the description and drawings, and from the claims.

### BRIEF DESCRIPTION OF THE DRAWINGS

FIG. 1A illustrates an example of a user interacting with a network-connected display device and a media adapter, according to implementations described throughout this disclosure.

FIG. 1B illustrates an example system for providing recommendations for media content for a user using large language models on a network-connected display device, according to implementations described throughout this disclosure

FIG. 2 is an illustration of an example process for creating, updating, and maintaining large language models on a network-connected display device, according to implementations described throughout this disclosure.

FIG. 3 is an illustration of an example process for fine-tuning or updating large language models on a network-connected display device, according to implementations described throughout this disclosure.

FIG. 4 is an illustration of an example process for training and fine-tuning large language models on a network-connected display device, according to implementations described throughout this disclosure.

FIG. 5 illustrates a flowchart depicting example operations of determining media content recommendations using an on-device model according to implementations described throughout this disclosure.

### DETAILED DESCRIPTION

A television (TV) application executing on a network-connected display device (e.g., a smart TV) may present a user with recommendations for media content that may be of interest to the user. The TV application may determine what the user may be interested in watching based on, for example, media content (e.g., movies, TV shows, short form videos, music, etc.) the user listened to, viewed, and/or watched in the past on the network-connected display device. In addition, or in the alternative, the TV application may determine what the user may be interested in watching based on, for example, the interest of the user in particular genres (e.g., comedy, romance, action, crime, reality, etc.) as determined from past user watch behavior or watch history on the network-connected display device.

In some implementations, a user of the network-connected display device may prefer not to have the watch history of the user shared outside of the confines of the network-connected display device. For example, the sharing of the watch behavior and watch history of the user may include interfacing with and/or communicatively coupling to one or more computing devices (e.g., servers) located outside of the network-connected display device. The user may prefer not to have the information and data of the user as gathered and/or stored by the TV application on the network-connected display device shared, sent, or provided to computing devices or other entities outside of the network-connected display device. The user may benefit from the use of a past watch history /d/ or behavior of the user with the TV application as a basis for determining and fine-tuning media content recommendations as provided by the TV application while maintaining the privacy of the user because the information and data related to the user is not shared, sent, or provided to other computing devices besides the network-connected display device.

At least one technical problem may be how to provide media content recommendations to a user based on their preferences and past user history without having to communicate, transfer, send, or receive user data between the network-connected display device running the TV application and a computing device (e.g., a server) outside of the network-connected display device. At least one technical solution may be the TV application gathering user activity (e.g., the watch behavior of the user, the interaction of the user with the TV application, the watch history of the user) on the network-connected display device using artificial intelligence and LLMs embedded on the network-connected display device without communicating with or otherwise interfacing with a computing device (e.g., a server) located outside of the network-connected display device. At least one technical effect may be minimizing and/or reducing network usage, and maintaining and/or enhancing the privacy of the user.

The disclosure generally relates to systems and methods for recommending media content to a user of a network-connected display device (e.g., a smart TV) that includes a television (TV) application facilitating the recommendation process by interfacing with an artificial intelligence (AI) module included on the network-connected display device. The AI module may include embedded large language models (LLMs) that the TV application may interface with to obtain recommended media content based on user information and data gathered by the TV application while executing on the network-connected display device. The TV application may gather the user information and data based on interactions of the user with the TV application without obtaining, sharing, sending, and/or providing the user data to any servers or computing devices outside of the network-connected display device. The TV application may not interact with any applications or computing devices outside of or otherwise communicatively coupled to the network-connected display device resulting in reduced network usage by the network-connected display device while maintain and enhancing the privacy of the user.

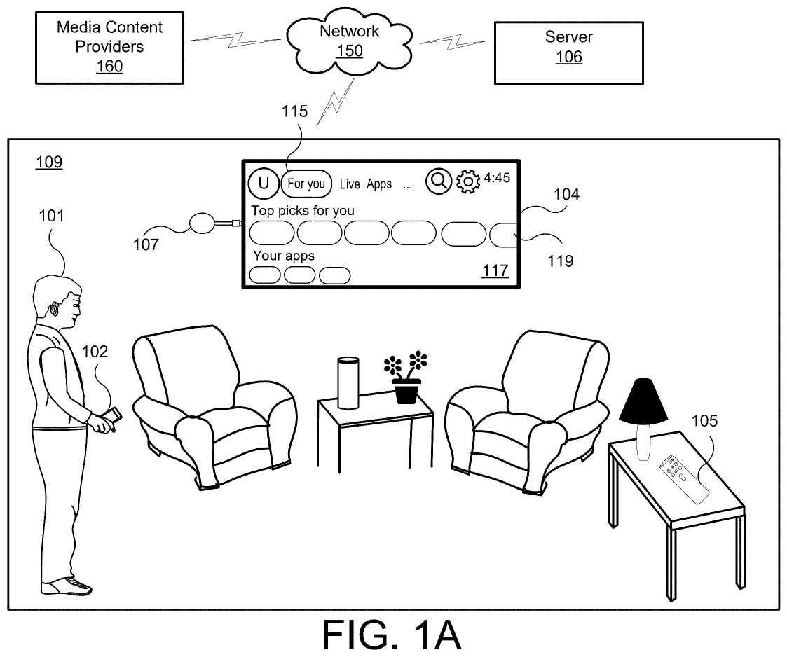

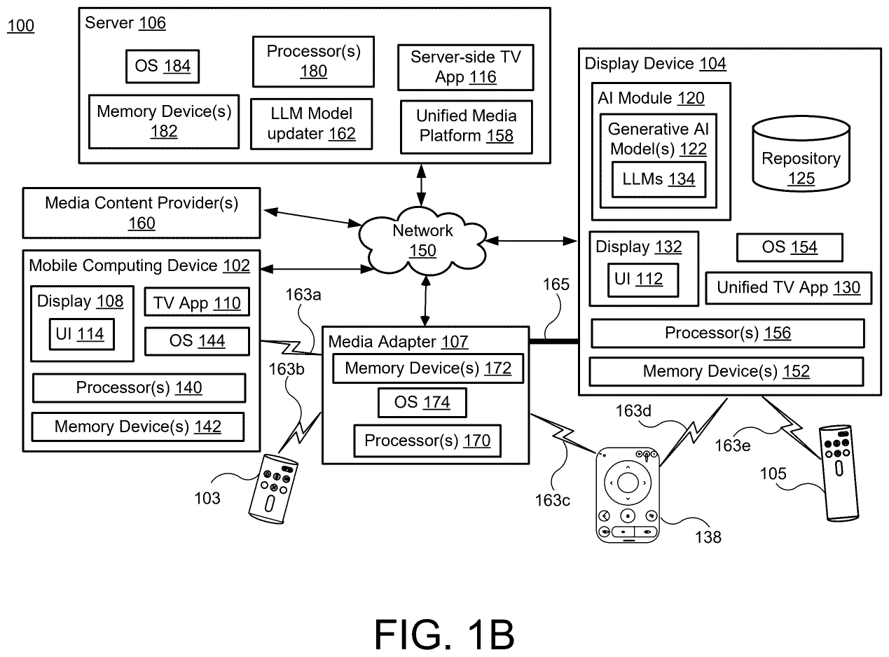

FIG. 1A illustrates an example of a user 101 interacting with a network-connected display device 104 and a media adapter 107 in an environment 109 of the user 101 (e.g., a room in the home of the user 101) according to implementations described throughout this disclosure. FIG. 1B illustrates an example system 100 for providing recommendations for media content for a user using large language models (LLMs) (e.g., LLMs 134) on a network-connected display device (e.g., the network-connected display device 104), according to implementations described throughout this disclosure.

Referring to FIGS. 1A-B, a unified television application 130 executing on the network-connected display device 104 may interact or interface with an artificial intelligence (AI) module 120 included on the network-connected display device 104. The AI module 120 may include one or more generative AI model(s) 122 such as the large language models (LLMs) 134. The unified television application 130 may determine media content recommendations for presenting in a top picks for you row 119 of user interface 117 displayed as a user interface (UI) 112 on a display 132 included in the network-connected display device 104. The unified television application 130 may integrate the media content recommendations in the user interface 117 by including the media content recommendations in the top picks for you row 119.

In some implementations, the user 101 may log into an account of the user 101 associated with the unified television application 130. For example, the unified television application 130 executing on the network-connected display device 104 may interface with a server-side TV application 116 executing on a server computer 106. The server-side TV application 116 may facilitate the logging into the account of the user 101 associated with the unified television application 130. The unified television application 130 may determine media content recommendations for presenting to the user 101 in the top picks for you row 119 based on a watch behavior, a watch history, and/or interactions of the user 101 with the unified television application 130 on the network-connected display device 104. The unified television application 130 may integrate the media content recommendations for presenting to the user 101 in the user interface 117 by integrating the media content recommendations in the top picks for you row 119 of the user interface 117. The unified television application 130 may interact or interface with the AI module 120 and run the LLMs 134. The LLMs 134 may be large language artificial intelligence models embedded on the network-connected display device 104. The unified television application 130 may recommend media content for the user 101 based on the activity of the user 101 with the unified television application 130 by running the LLMs 134 on the network-connected display device 104.

In these implementations, the unified television application 130 may not provide, share, send, or transfer user data related to the activities of the user 101 with the unified television application 130 on the network-connected display device 104 to a computing device (or any other device) outside of the network-connected display device 104, such as, for example the server computer 106. Because the unified television application 130 may not provide, send, share, or transfer user activity data outside of the network-connected display device 104, network usage may be reduced (e.g., interactions of the network-connected display device 104 with a network 150). In addition, or in the alternative, because the unified television application 130 may not provide, send, share, or transfer user activity data outside of the network-connected display device 104, a privacy of the user 101 may be maintained or enhanced as the activities of the user 101 when interacting with the unified television application 130 may not be provided, shared, transferred, or sent to or communicated with any other computing devices outside of the network-connected display device 104.

The unified television application 130 may gather information and data related to the usage or interactions of the user 101 with the unified television application 130 as the user 101 watches or otherwise consumes or interacts with media content items displayed or played on the network-connected display device 104. For example, the unified television application 130 may gather information and data related to the usage or interactions of the user 101 with the unified television application 130 that may be used to build and train the LLMs 134. The LLMs 134 may be trained using machine learning. The information and data may include, but is not limited to, user activity and interactions of the user 101 with user interfaces (e.g., user interface 117) provided by the unified television application 130 such as user selections or clicks, user watch history such as media content items watched or consumed (e.g., listened to) by the user 101 while interacting with the unified television application 130 on the network-connected display device 104, a location of the network-connected display device 104 (e.g., a geographic location, a room location), a language used by the user 101 when interacting with the network-connected display device 104 and the unified television application 130, and a language of the media content items watched or consumed by the user 101 while interacting with the unified television application 130 on the network-connected display device 104.

The unified television application 130 may tweak or fine-tune the media content recommendations based on the retraining of the LLMs 134. For example, the AI module 120 may use the watch history of the user, and/or the user activity and/or the interactions of the user 101 with the unified television application 130 to train the LLMs 134. In some implementations, the unified television application 130 may store information and data associated with the activities and/or interactions of the user 101 with the unified television application 130 in a repository 125. The unified television application 130 may store the information and data in association with an identifier of the user 101 (e.g., a login identifier of the user for the unified television application 130). The information and data associated with the user 101 and stored in the repository 125 may be provided to or accessed by the AI module 120. The AI module 120 may interface with the generative AI model(s) 122 and specifically the LLMs 134 to generate media content recommendations for serving to and playing by the unified television application 130 on the network-connected display device 104 that may be relevant and/or of interest to the user 101.

Referring to FIGS. 1A-B, the network-connected display device 104 may communicate with the server computer 106 and media content providers 160 by way of the network 150. The media content providers 160, the network-connected display device 104, the server computer 106, and a mobile computing device 102 may interact with and communicate with one other by way of the network 150. In some implementations, the mobile computing device 102 may interface or connect to the media adapter 107 and/or the network-connected display device 104 by way of a wireless communication link that may be a short-range wireless connection such as, for example a Bluetooth connection or a Wi-Fi (e.g., direct Wi-Fi) connection. Though the network-connected display device 104 may interface with and/or communicate with the server computer 106, the media content providers 160 the mobile computing device 102 and/or the media adapter 107, the network-connected display device 104 may not provide, share, send, transfer, or transmit any information and data related to the interactions of the user 101 with the unified television application 130.

In some implementations, a user (e.g., the user 101) may use and/or otherwise interact with the network-connected display device (e.g., network-connected display device 104). For example, a user may log into or otherwise access the account of the user by way of the network-connected display device allowing the user to experience a customized user experience when interacting with a television (TV) application (e.g., unified television (TV) application 130) on the network-connected display device (e.g., the network-connected display device 104). Though the interactions of the user 101 are described herein with reference to the system 100, in some implementations a user (e.g., the user 101) may use and/or otherwise interact with different network-connected display devices, mobile computing devices, media adapters, networks, and servers that perform like the system 100. In these implementations, the user may experience a customized user experience when interacting with a television (TV) application on the network-connected display device without the network-connected display device providing, sharing, transmitting, or transferring any information and data related to the user as gathered by the TV application on the network-connected display device to any of the different network-connected display devices, mobile computing devices, media adapters, networks, and servers.

For example, the user 101 may select or click on the for you option 115 when interacting with the unified television (TV) application 130 on the network-connected display device 104. In response to the selection of the for you option 115, the unified TV application 130 may display a user interface 117 that provides the user 101 with media recommendations in the top picks for you row 119 in the user interface 117. In some implementations, the unified TV application 130 may display the user interface 117 in the UI 112 of a display 132 of the network-connected display device 104 in response to the launching of the unified TV application 130 on the network-connected display device 104. In these implementations, the user interface 117 may be referred to as the launch screen or home screen for the unified TV application 130. The unified TV application 130 may provide the media recommendations in the user interface 117 as a customized user experience based on a watch history of the user and other preferences of the user that remain local to the network-connected display device 104 and that are not shared or communicated to computing devices outside of the network-connected display device 104.

In some implementations, referring to FIG. 1A, the user 101 may connect to and interact with a media adapter (e.g., the media adapter 107) by way of a network-connected display device (e.g., the network-connected display device 104) using a server-side television (TV) application (e.g., server-side TV application 116) installed on a server computer (e.g., the server computer 106). The media adapter 107 may be connected or interfaced to the network-connected display device 104. The network-connected display device 104 may be communicatively coupled or connected to the server computer 106 by way of the network 150. In these implementations, a unified media platform (UMP) 158 may provide or serve media content items from the media content providers 160 to the network-connected display device 104 by way of the media adapter 107.

In some implementations, referring to FIG. 1A, the user 101 may interact with a network-connected display device (e.g., the network-connected display device 104) using a remote control device (e.g., a remote control device 105). In some implementations, a television (TV) application 110 may render a virtual remote control 138 in a user interface (e.g., UI 114) on a display (e.g., a mobile computing device display 108) on the mobile computing device 102. The virtual remote control 138 may allow the mobile computing device 102 to act as a remote control for the network-connected display device 104. The TV application 110 may render the virtual remote control 138 for use with the network-connected display device 104. The user may interact with the remote control device 105 and/or the virtual remote control 138 when selecting media content for viewing on the network-connected display device 104.

In some implementations, referring to FIG. 1A, the user 101 may connect to and interact with a media adapter (e.g., the media adapter 107) using a TV application (e.g., the television (TV) application 110) installed on a mobile computing device (e.g., the mobile computing device 102). In some implementations, the user 101 may connect to and interact with a media adapter (e.g., the media adapter 107) using a media adapter remote control device (e.g., media adapter remote control device 103). In some implementations, the TV application 110 may render the virtual remote control 138 for use with the media adapter 107. The virtual remote control 138 may allow the mobile computing device 102 to act as a remote control for the media adapter 107. The user 101 may interact with the virtual remote control 138 and/or the media adapter remote control device 103 when interacting with the media adapter 107.

The network-connected display device 104 may execute the unified television application 130. The unified television application 130 may interface with the server-side television (TV) application 116. The server-side TV application 116 may interface with a unified media platform (UMP) 158 to facilitate the providing or serving of media content items from the media content providers 160 to the network-connected display device 104.

The server computer 106 may include a large language model updater (e.g., LLM updater 162). The LLM updater 162 may provide or send updates to the network-connected display device 104 for use by the AI module 120 for updating or maintaining the LLMs 134 included on the network-connected display device 104. The updates may include updated and/or new media content items from the media content providers 160 that may be used by the LLMs 134 when determining media content recommendations for the user 101.

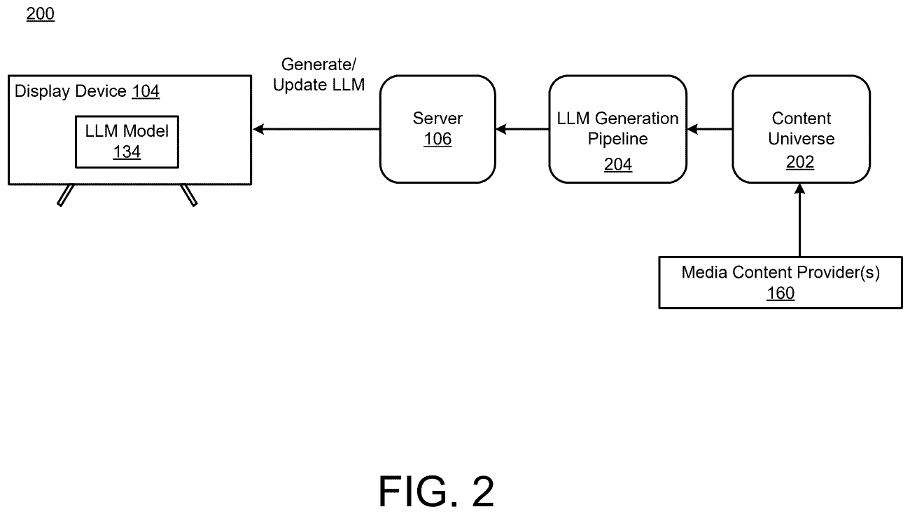

FIG. 2 is an illustration of an example process 200 for creating, updating, and maintaining large language models (e.g., LLMs 134) on a network-connected display device (e.g., the network-connected display device 104), according to implementations described throughout this disclosure. For example, referring to FIGS. 1A-B, the unified television application 130 executing on the network-connected display device 104 may recommend media content of interest to the user 101 using the AI module 120 and the LLMs 134 that reside on the network-connected display device 104. The interactions and activity of the user with the unified television application 130 may be stored as information and data associated with the user 101 in the repository 125 included in the network-connected display device 104. The information and data associated with the user 101 may not be provided, sent, or otherwise shared with computing devices outside of the network-connected display device 104. The unified television application 130 interacting with the AI module 120 may use the information and data associated with the user 101 and stored in the repository 125 to create LLMs 134. The unified television application 130 may use the LLMs 134 to generate media content for recommending to the user 101.

In some implementations, a large language model updater (e.g., LLM updater 162) included on the server computer 106 may provide or send updates to the network-connected display device 104 for use by the AI module 120 for updating or maintaining the LLMs 134 included on the network-connected display device 104. The updates may include updated and/or new media content items from the media content providers 160. The media content providers 160 may provide or send information and data related to the updated and/or new media content items to a content universe 202. A large language model generation pipeline 204 may access the content universe 202 to provide or send the information and data related to the updated and/or new media content items to the server computer 106. The LLM updater 162 on the server computer 106 may use the information and data related to the updated and/or new media content items to provide and/or send updated information and data to the network-connected display device 104 for use by the AI module 120 for updating and/or maintaining the LLMs 134. The periodic updating of the LLMs 134 may optimize the engagement of the user 101 with the unified television application 130 by recommending new and additional media content items to the user 101.

In some implementations, the content universe 202 and the large language model generation pipeline 204 may be included on the server computer 106. In some implementations, the content universe 202 may be provided by the media content providers 160 and the large language model generation pipeline 204 may be included on the server computer 106. In some implementations, the content universe 202 and the large language model generation pipeline 204 may be included on a content server computer that may be accessed by the server computer 106 and the media content providers 160 by way of a network (e.g., the network 150). For example, the content server computer may be a cloud computing device.

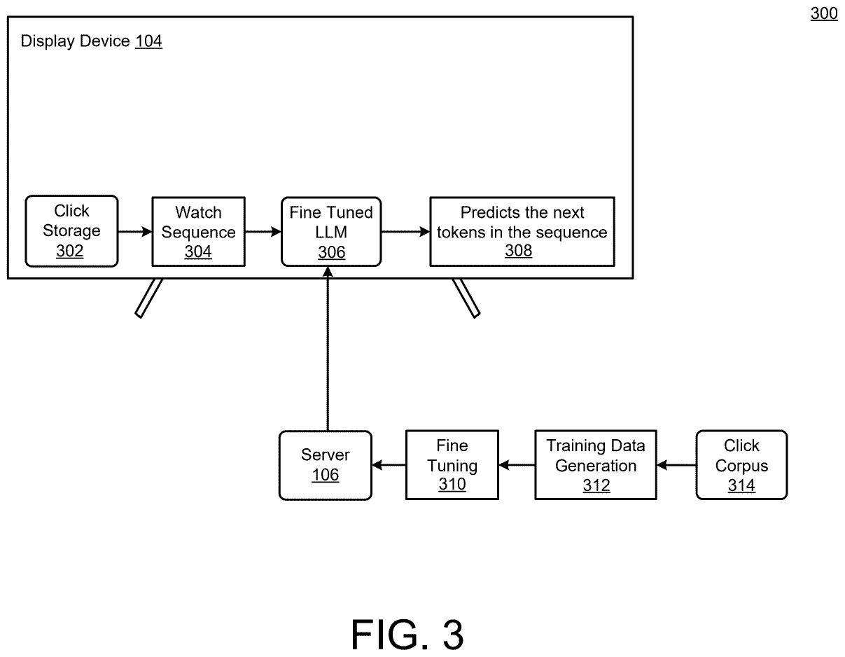

FIG. 3 is an illustration of an example process 300 for fine-tuning or updating large language models (e.g., LLMs 134) on a network-connected display device (e.g., the network-connected display device 104), according to implementations described throughout this disclosure. For example, referring to FIGS. 1A-B, the unified television application 130, interfacing with the AI module 120 that uses the LLMs 134, may provide media content recommendations to the user 101. The AI module 120 may use the LLMs 134 to generate media content recommendations for user 101. The AI module 120 may receive information and data related to the activities and interaction of user 101 with the unified television application 130 that may be saved or stored in click storage 302 in association with the user 101. The network-connected display device 104 may include the click storage 302. For example, the repository 125 may include the click storage 302. The AI module 120 may use the information and data related to the activities and interaction of user 101 with the unified television application 130 that is included in the click storage 302 to define a watch sequence 304. For example, the watch sequence 304 may be a sequence of selections made by a user while reviewing and selecting media content for viewing. The AI module 120 may use the watch sequence 304 to fine-tune one or more LLMs included in the LLMs 134 resulting in at least one fine-tuned LLM (fine-tuned LLM 306). For example, the fine-tuned LLM 306 may be associated with the user 101. The AI module 120 may use the fine-tuned LLM 306 trained by the watch sequence 304 for the user to predict the next token in a sequence of tokens 308 (e.g., a next selection by the user 101 is a series of selections by the user). For example, a token may be a particular media content item such as a movie or television show.

In addition, or in the alternative, the server computer 106 may send or provide additional information and data to the network-connected display device 104 for use by the AI module 120 when fine-tuning one or more LLMs included in the LLMs 134 to generate at least one fine-tuned LLM (e.g., the fine-tuned LLM 306). The AI module 120 may use machine learning to fine-tune or train the LLMs 134. For example, a click corpus 314 may store a collection of user clicks or selections for many users of a network-connected display device and a TV application. The information and data included in the click corpus 314 may be used to generate training data (e.g., training data generation 312). The training data generated may be used for fine-tuning 310 one or more LLMs included on the network-connected display device 104 resulting in, for example, the fine-tuned LLM 306. For example, the LLM updater 162 included on the server computer 106 may use the training data to help fine-tune the fine-tuned LLM 306. The fine-tuned LLM 306 may be fine-tuned and trained using watch sequence 304 information and data based on the click storage 302 along with training data that is generated based on the click corpus 314.

In some implementations, the click corpus 314, the training data generation 312, and the fine-tuning 310 may be included on the server computer 106. In some implementations, the click corpus 314, the training data generation 312, and the fine-tuning 310 may be included on a LLM server computer that may be accessed by the server computer 106 by way of a network (e.g., the network 150). For example, the LLM server computer may be a cloud computing device.

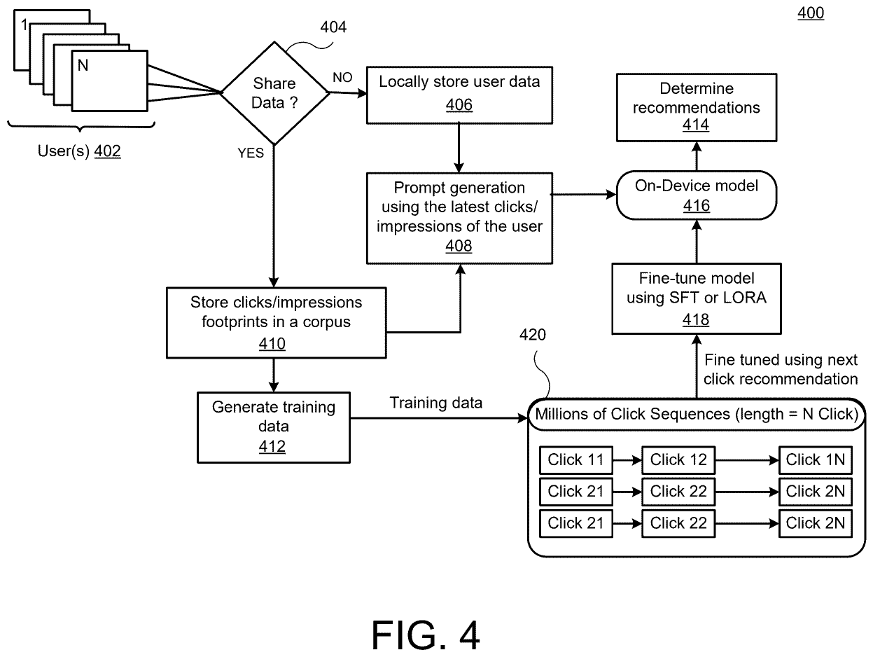

FIG. 4 is an illustration of an example process 400 for training and fine-tuning large language models (e.g., LLMs 134) on a network-connected display device (e.g., the network-connected display device 104), according to implementations described throughout this disclosure. For example, the LLMs 134 may be hosted on the network-connected display device 104 which may be a low-capacity computing device. The capacity of a computing device may refer to the storage and/or computing or processing capacity of the computing device. In some implementations, the computing device may provide a computing capacity at a level that can train, fine-tune, and manage LLMs 134 while providing media content recommendations to the user 101 using the unified television application 130 in a timely manner such that the user 101 has a good user experience. In some implementations, the network-connected display device 104 may have limited storage and computing capabilities as compared to a server computing device. In these implementations, it may be beneficial to start with smaller and/or simpler large language models that may not require a large number of parameters (e.g., less than ten billion parameters) as compared to larger more complex large language models. The use of the smaller and/or simpler LLMs may provide the user 101 with a good user experience by providing media content recommendations in the unified television application 130 without obtaining, sharing, sending, and/or providing user data to any servers or computing devices outside of the network-connected display device 104.

In some implementations, the process 400 may fine-tune the LLMs 134 on the network-connected display device 104 using two processes. A first process may be referred to as supervised fine-tuning (SFT). SFT may change a base large language model and then create a new instance of the large language model. SFT may use substantial amounts of training data (e.g., 100,000 data samples) that may be difficult to obtain. A second process may be low rank optimization (LORA). LORA may not change the base large language model, therefore, LORA may be use less training data (data samples) and may be less expensive to implement as compared to SFT. LORA may require the hosting of the base large language model and the trained matrix for the large language model (e.g., 1,000 samples) on the network-connected display device 104. In addition, or in the alternative, LORA may decide the rank of the trained matrix as hosted on the network-connected display device 104. For example, a lower rank may result in the use of less storage space on the network-connected display device 104. However, the use of less storage space may impact the learning or training of the large language models. As such, a balance may be determined and maintained between model learning and model size.

In some implementations, referring to FIG. 1B, the AI module 120 may use a sequential watch action chain to train a large language model (e.g., a LLM included in the LLMs 134). For example, assume that the user 101 watched five movies in the past in the following sequence: Movie1, Movie2, Movie 3, Movie 4, Movie5. These movies are in a sequence of the order that the user 101 has watched them in (i.e., the earliest watched movie is Movie1 and last watched movie is Movie5) and may be considered a sequential watch action chain. The AI module 120 in training the LLMs 134 may remove random movies from the sequence of movies. The AI module 120 may ask the large language model being trained to predict the missing movie from the sequence. For example, the AI module 120 may remove 15 % of the movies in the sequence randomly, replacing the removed movies in the sequence with a placeholder token (e.g., a placeholder movie). The AI module 120 may fine-tune the large language model by asking the large language model to predict the missing tokens (e.g., the missing movies) in the sequence. In some implementations, the AI module 120 may utilize SFT to fine-tune the large language model. In this implementation, SFT may use a substantial quantity of data using a clicks storage corpus to create a user specific watch action sequence (e.g., a fine-tuned sequential watch action chain).

Once the large language model is fine-tuned, the AI module 120 may use the fine-tuned large language model to predict the next token (e.g., movie) to be watched by the user given the past number of actions (e.g., X number of actions) of the user performed in a sequential manner. The AI module 120 may tune the value of X using live experiments. The AI module 120 may determine which context length is giving the maximum amount of improvement in the expected metrics.

Referring to FIGS. 1A-B, 2, 3, and 4, in some implementations, users of a TV application executing on a network-connected display device (e.g., user(s) 402 which may include the user 101 of the unified television application 130 executing on the network-connected display device 104) may select to share or not share information and data related to the interaction of the user with the TV application (step 404). The information and data related to the interaction of the user(s) 402 with a television application may include, but is not limited to, user activity and interactions of the user(s) 402 with user interfaces (e.g., the user interface 117) provided by the TV application (e.g., the unified television application 130) such as user selections or clicks, user watch history such as media content items watched or consumed (e.g., listened to) by the user(s) 402 (e.g., the user 101) while interacting with a TV application (e.g., the unified television application 130) on a network-connected display device (e.g., the network-connected display device 104), a location of a network-connected display device 104 (e.g., the network-connected display device 104) (e.g., a geographic location, a room location), a language used by the user(s) 402 (e.g., the user 101) when interacting with a network-connected display device (e.g., the network-connected display device 104) and a TV application (e.g., the unified television application 130), and a language of the media content items watched or consumed by the user(s) 402 (e.g., the user 101) while interacting with a TV application (e.g., the unified television application 130) on a network-connected display device (e.g., the network-connected display device 104).

For example, if the user 101 selects to share information and data related to the interaction of the user 101 with the unified television application 130, the network-connected display device 104 may send or provide the information and data (e.g., clicks/impression footprints) for storage in a corpus (step 410). Referring to FIG. 3, the click corpus 314 may store the clicks/impressions footprints for one or more users of a TV application. The click corpus 314 may store a collection of user clicks or selections for many users of a network-connected display device and a TV application that have selected to share the user clicks and selections. The information and data may be clicks/impressions footprints for use in generating training data (step 412).

In some implementations, criteria gathered and stored for a click or selection of a media content item by a user of a television application may include, but is not limited to, a time of day of the click or selection, a number of times a media content item was clicked or selected, a day of the week of the click or selection, a channel or program identification for the clicked on or selected media content item, if the media content item clicked on or selected was on live television, and a name of the media content item clicked on or selected.

Generated training data 420 may be used for fine-tuning a LLM on the network-connected display device (step 418). For example, the fine-tuning may involve the use of a next click recommendation based on the generated training data 420. As described, the For example, the LLM updater 162 included on the server computer 106 may use the generated training data 420 to help fine-tune an on-device model 416 (e.g., the fine-tuned LLM 306 included on the network-connected display device 104). In addition, or in the alternative, the generated training data (step 412) may be sent or provided to the network-connected display device 104 for use in generating an on-device model 416 (step 408).

For example, if the user 101 selects not to share information and data related to the interaction of the user 101 with the unified television application 130 (step 404), the network-connected display device 104 may not send or provide the information and data to the clicks/impressions footprints corpus (e.g., the click corpus 314). The network-connected display device 104 may not send, share, or provide information and data related to the interaction of the user 101 with the unified television application 130 to any computing device outside of the network-connected display device 104. For example, the unified television application 130 may store the information and data related to the interaction of the user 101 with the unified television application 130 in storage on the network-connected display device 104 (step 406). For example, the unified television application 130 may store the information and data related to the interaction of the user 101 with the unified television application 130 in the repository 125 of the network-connected display device 104.

In some implementations, the storing of the information and data related to the interaction of the user 101 with the unified television application 130 in local storage may prompt the generation of an on-device model 416 (step 408). For example, the AI module 120 may generate an on-device model 416. The on-device model 416 may be a LLM included in the LLMs 134. The AI module 120 may generate the on-device model 416 using the locally stored user data on the network-connected display device 104. In addition, or in the alternative, the AI module 120 may generate the on-device model 416 using the clicks/impression footprints for one or more user(s) 402 stored in a corpus (e.g., the click corpus 314) outside of the network-connected display device 104.

In some implementations, the AI module 120 may fine-tune the on-device model 416 on the network-connected display device 104 using one of two processes: a supervised fine-tuning (SFT) process or a low rank optimization (LORA) process (step 418), as described herein. The unified television application 130 may interface with the AI module 120 to use the on-device model 416 to determine recommendations for providing to the user 101 of the unified television application 130 on the network-connected display device 104 (step 414).

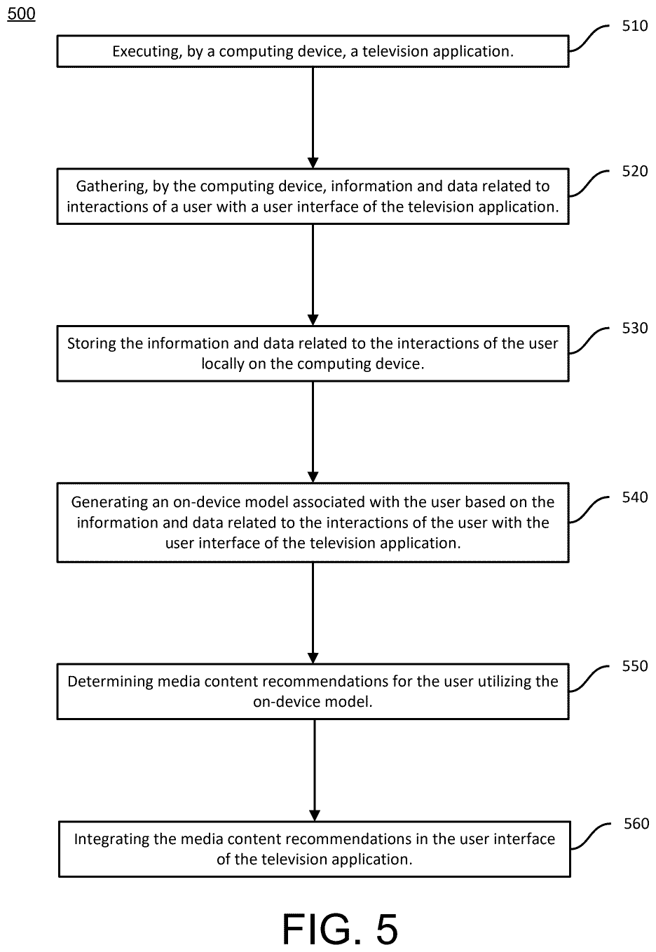

FIG. 5 illustrates a flowchart depicting example operations of determining media content recommendations using an on-device model according to implementations described throughout this disclosure. Although the flowchart 500 of FIG. 5 illustrates the operations in sequential order, it will be appreciated that this is merely an example, and that additional or alternative operations may be included. Further, operations of FIG. 5 and related operations may be executed in a different order than that shown, or in a parallel or overlapping fashion. The operations may define a computer-implemented method. Although the flowchart 500 is described with reference to the system 100 of FIG. 1B, the flowchart 500 may be executed according to any of the figures discussed herein. In some examples, the operations of the flowchart 500 are executed by the network-connected display device 104.

Operation 510 includes executing, by a computing device, a television application.

Operation 520 includes gathering, by the computing device, information and data related to interactions of a user with a user interface of the television application.

Operation 530 includes storing the information and data related to the interactions of the user locally on the computing device.

Operation 540 includes generating an on-device model associated with the user based on the information and data related to the interactions of the user with the user interface of the television application.

Operation 550 includes determining media content recommendations for the user utilizing the on-device model.

Operation 560 includes integrating the media content recommendations in the user interface of the television application.

In some examples, the techniques described herein relate to a method including: executing, by a computing device, a television application; gathering, by the computing device, information and data related to interactions of a user with a user interface of the television application; storing the information and data related to the interactions of the user locally on the computing device; generating an on-device model associated with the user based on the information and data related to the interactions of the user with the user interface of the television application; determining media content recommendations for the user utilizing the on-device model; and integrating the media content recommendations in the user interface of the television application.

In some examples, the techniques described herein relate to a method, wherein the on-device model is embedded on the computing device.

In some examples, the techniques described herein relate to a method, wherein the on-device model is a large language model.

In some examples, the techniques described herein relate to a method, wherein the information and data associated with the user is not shared with any other computing devices.

In some examples, the techniques described herein relate to a method, wherein the information and data include activities and interactions of the user with the television application.

In some examples, the techniques described herein relate to a method, wherein the activities and interactions include at least one of selections or clicks by the user, a watch history of the user, a location of the computing device, a language used by the user when interacting with the television application, and a language of media content items watched or consumed by the user.

In some examples, the techniques described herein relate to a method, further including: receiving additional training data; and fine-tuning the on-device model based on the received additional training data.

In some examples, the techniques described herein relate to a method, wherein the fine-tuning uses one of a supervised fine-tuning process or a low rank optimization process.

In some examples, the techniques described herein relate to a method, herein the computing device is a network-connected display device.

In some examples, the techniques described herein relate to a method, wherein the network-connected display device is a smart television.

In some examples, the techniques described herein relate to a non-transitory computer-readable medium storing executable instructions that when executed by at least one processor of a network-connected display device cause the at least one processor to execute operations, the operations including: executing a television application; gathering information and data related to interactions of a user with a user interface of the television application; storing the information and data related to the interactions of the user locally on the network-connected display device; generating an on-device model associated with the user based on the information and data related to the interactions of the user with the user interface of the television application; determining media content recommendations for the user utilizing the on-device model; and integrating the media content recommendations in the user interface of the television application.

In some examples, the techniques described herein relate to a non-transitory computer-readable medium, wherein the on-device model is embedded on the network-connected display device.

In some examples, the techniques described herein relate to a non-transitory computer-readable medium, wherein the on-device model is a large language model.

In some examples, the techniques described herein relate to a non-transitory computer-readable medium, wherein the information and data associated with the user is not shared with any other computing devices.

In some examples, the techniques described herein relate to a non-transitory computer-readable medium, wherein the information and data include activities and interactions of the user with the television application.

In some examples, the techniques described herein relate to a non-transitory computer-readable medium, wherein the operations further include: receiving additional training data; and fine-tuning the on-device model based on the received additional training data.

In some examples, the techniques described herein relate to a non-transitory computer-readable medium, wherein the fine-tuning uses one of a supervised fine-tuning process or a low rank optimization process.

In some examples, the techniques described herein relate to a system including: at least one processor; and a non-transitory computer-readable medium storing instructions that when executed by the at least one processor cause the system to: execute a television application; gather information and data related to interactions of a user with a user interface of the television application; store the information and data related to the interactions of the user locally on the system; generate an on-device model associated with the user based on the information and data related to the interactions of the user with the user interface of the television application; determine media content recommendations for the user utilizing the on-device model; and integrate the media content recommendations in a user interface of the television application.

In some examples, the techniques described herein relate to a system, wherein the on-device model is embedded on the system.

In some examples, the techniques described herein relate to a system, wherein the information and data associated with the user is not shared with any other systems.

Referring to FIGS. 1A-B, the mobile computing device 102 may be configured to execute the TV application 110. The mobile computing device 102 may include the mobile computing device display 108 configured to display the UI 114. A user may interact with the UI 114 to set up, control, and interact with the TV application 110. In some implementations, as described, the TV application 110 may display the virtual remote control 138 in the UI 114 allowing the user 101 to interact with and control the network-connected display device 104 and/or the media adapter 107.

The mobile computing device 102 may be any type of computing device that includes one or more processors (processor(s) 140), one or more memory devices (memory device(s) 142), and an operating system 144. The mobile computing device 102 may be a smartphone, a tablet, a wearable device, a laptop computer, or a desktop computer. In some implementations, the operating system 144 may be system software that manages computer hardware, software resources, and provides common services for computing programs.

In some implementations, the mobile computing device 102 may be a tablet, a smartphone, or a wearable. In these implementations, the operating system 144 may be referred to as a mobile operating system. The mobile operating system may be configured to execute on devices that, in general, include display devices that may be smaller in size than, for example, a display device included in a laptop computer or a desktop computer. In some implementations, the mobile computing device 102 may be a laptop computer. In these implementations, the operating system may be referred to as a laptop or desktop operating system. In these implementations, the operating system 144 may be an operating system designed for a display that is larger in size than that included in a tablet, a smartphone, or a wearable.

In some implementations, the media adapter 107 (e.g., a casting device, a media streaming device, a media streaming player, a set-top box) may be interfaced with or connected to the network-connected display device 104. The media adapter 107 may interact with and communicate with the media content providers 160, the server computer 106, and the mobile computing device 102 when providing media content to the network-connected display device 104. In some implementations, the media adapter 107 may be embedded in and/or an integrated part of the network-connected display device 104.

The media content providers 160 may include a variety of streaming service and media content sources and service platforms. The media adapter 107 may facilitate providing (e.g., streaming) media content (e.g., streaming video such as movies, TV shows, etc.) from one or more streaming services included in the media content providers 160 to the network-connected display device 104. For example, the media adapter 107 may directly connect to a connector on the network-connected display device 104 by way of connection 165. The media adapter 107 may provide digital video and/or audio to the network-connected display device 104. For example, the media adapter 107 may connect to a high-definition multimedia interface (HDMI) connector included in the network-connected display device 104. Examples of the media adapter 107 may include, but are not limited to, a set-top box, a television box, and a streaming media adapter.

In some implementations, the mobile computing device 102 may connect to or interface with the media adapter 107 by way of a wireless communication link 163a. Wireless communication links 163a-e may be short-range wireless connections such as a Bluetooth connection. In some examples, wireless communication links 163a-e may be a Wi-Fi (e.g., direct Wi-Fi) connection.

The media adapter 107 may be any type of computing device that includes one or more processors (processor(s) 170), one or more memory devices (memory device(s) 172), and an operating system 174. In some implementations, the processor(s) 170 may include a system on a chip (SoC). The SoC may include a central processing unit (CPU), a graphic processing unit (GPU), one or more memory interfaces, and one or more input/output interfaces and devices. In some implementations, the operating system 174 may be system software that manages computer hardware, software resources, and provides common services for computing programs.

The network-connected display device 104 may include the unified television application 130. The unified television application 130 may keep a record of the interactions of the user with the media content received from the server computer 106. The network-connected display device 104 may send the record of the interactions to the server computer 106 for use in determining future media content recommendations for the user.

In some implementations, the network-connected display device 104 may be configured to execute the unified television application 130. For example, the network-connected display device 104 may be a smart television. For example, a smart television may be a network-connected television that may connect to media content providers (e.g., media content providers 160) by way of a network (e.g., the network 150). The media content providers may source media content to the smart television. In these implementations, a user may interact with the unified television application 130 to access media content from the media content providers 160. The unified television application 130 may interface with the server computer 106, and specifically with the server-side TV application 116. The unified television application 130 may provide similar functionality to the user as that provided by an application executing on the media adapter 107. For example, executing the unified television application 130 by the network-connected display device 104 allows the network-connected display device 104 to obtain a media content recommendation stream from the server computer 106.

The network-connected display device 104 may be configured to connect to the network 150. In some implementations, the network-connected display device 104 is a television (e.g., a smart television (TV)). The network-connected display device 104 may include one or more processors (processor(s) 156), one or more memory devices (memory device(s) 152), and an operating system (OS) 154. The operating system 154 may execute (or assist with executing) the unified television application 130.

In some implementations, the operating system 154 may be a browser application. A browser application is a web browser configured to access information on the Internet by way of a network (e.g., the network 150). A browser application may launch one or more browser tabs in the context of one or more browser windows in the browser application. In some implementations, the operating system 154 is a Linux-based operating system configured to execute (or assist with executing) the unified television application 130.

The system 100 may include one or more server computers (e.g., the server computer 106) configured to interface with the mobile computing device 102, the media adapter 107, the media content providers 160, and the network-connected display device 104 by way of the network 150. In some implementations, the network 150 may establish a wireless communication link between the network-connected display device 104, the mobile computing device 102, the media adapter 107, the media content providers 160, and the server computer 106.

The server computer 106 may include the unified media platform (UMP) 158. The UMP 158 may facilitate the providing of media content items to the network-connected display device 104 as described herein.

The server computer 106 may include the server-side TV application 116. The server-side TV application 116 may facilitate providing the media content items for playing on the network-connected display device 104.

The mobile computing device 102 may include the mobile computing device display 108. In some implementations, the mobile computing device display 108 is a display device such as a liquid crystal display (LCD), a light-emitting diode (LED) display, an organic light-emitting diode (OLED) display, or an active-matrix organic light-emitting diode (AMOLED) display. The network-connected display device 104 may include the display 132. In some implementations, the display 132 is a display device such as a liquid crystal display (LCD), a light-emitting diode display (LED) display, a plasma display, a quantum dot light-emitting diode display (QLED) display, or an organic light-emitting diode (OLED) display.

The processor(s) 156, the processor(s) 140, the processor(s) 170, and the processor(s) 180 may be formed in a substrate configured to execute one or more machine executable instructions or pieces of software, firmware, or a combination thereof. The processor(s) 156, the processor(s) 140, the processor(s) 170, and the processor(s) 180 may be semiconductor-based. For example, the processor(s) 156, the processor(s) 140, the processor(s) 170, and the processor(s) 180 may include semiconductor material that can perform digital logic.

The memory device(s) 152, the memory device(s) 142, the memory device(s) 172, and the memory device(s) 182 may include main memory that stores information in a format that can be read and/or executed by the processor(s) 156, the processor(s) 140, the processor(s) 170, and the processor(s) 180 respectively. The memory device(s) 152, the memory device(s) 142, the memory device(s) 172, and the memory device(s) 182 may include one or more random-access memory (RAM) devices and/or one or more read-only memory (ROM) devices.

The memory device(s) 152, memory device(s) 142, the memory device(s) 172, and the memory device(s) 182 may store applications that, when executed by the processor(s) 156, the processor(s) 140, the processor(s) 170, and the processor(s) 180, respectively, perform operations. For example, the memory device(s) 142 may store the operating system 144 and the TV application 110 that, when executed by the processor(s) 140, may perform operations on the mobile computing device 102. For example, the memory device(s) 152 may store the operating system 154, the LLMs 134, the Generative AI model(s) 122, and the unified television application 130 that, when executed by the processor(s) 156, may perform operations on the network-connected display device 104.

In some implementations, the memory device(s) 182 may represent any kind of (or multiple kinds of) memory (e.g., RAM, flash, cache, disk, tape, etc.). In some implementations, the memory device(s) 182 may include external storage, e.g., memory physically remote from but accessible by the server computer 106. The server computer 106 may include one or more modules, engines, or applications representing specially programmed software. In some implementations, the server computer 106 may include the operating system 184, the server-side TV application 116, the UMP 158, LLM model updater 162, processor(s) 180, and memory device(s) 182. For example, the memory device(s) 182 may store the operating system 184, the server-side TV application 116, the UMP 158, and the LLM model updater 162 that, when executed by the processor(s) 180, may perform operations on server computer 106 to implement one or more of the methods and processes described herein.

The network 150 may include the Internet and/or other types of data networks, such as a local area network (LAN), a wide area network (WAN), a cellular network, satellite network, or other types of data networks. The network 150 may also include any number of computing devices (e.g., computer, servers, routers, network switches, etc.) that are configured to receive and/or transmit data within the network 150. The network 150 may further include any number of hardwired and/or wireless connections. The network 150 may be, for example, communications networks having one or more types of topologies, including but not limited to the Internet, intranets, local area networks (LANs), cellular networks, Ethernet, Storage Area Networks (SANs), telephone networks, and Bluetooth personal area networks (PAN). In some implementations, two or more devices in a sub-network may be coupled by way of a wired connection, while at least some of the devices in the same sub-network are coupled by way of a local radio communication network (e.g., ZigBee, Z-Wave, Insteon, Bluetooth, Wi-Fi and other radio communication networks).

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or non-transitory medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the embodiments disclosed herein unless the element is specifically described as “essential”or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

Further to the descriptions above, a user may be provided with controls allowing the user to make an election as to both if and when systems, programs, or features described herein may enable collection of user information (e.g., a user's preferences, a user's current location, a user's credentials, etc.), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

What is claimed is:

1. A method comprising:
executing, by a computing device, a television application;
gathering, by the computing device, information and data related to interactions of a user with a user interface of the television application;
storing the information and data related to the interactions of the user locally on the computing device;
generating an on-device model associated with the user based on the information and data related to the interactions of the user with the user interface of the television application;
determining media content recommendations for the user utilizing the on-device model; and
integrating the media content recommendations in the user interface of the television application.

2. The method of claim 1, wherein the on-device model is embedded on the computing device.

3. The method of claim 2, wherein the on-device model is a large language model.

4. The method of claim 1, wherein the information and data associated with the user is not shared with any other computing devices.

5. The method of claim 1, wherein the information and data include activities and interactions of the user with the television application.

6. The method of claim 5, wherein the activities and interactions include at least one of selections or clicks by the user, a watch history of the user, a location of the computing device, a language used by the user when interacting with the television application, and a language of media content items watched or consumed by the user.

7. The method of claim 1, further comprising:
receiving additional training data; and
fine-tuning the on-device model based on the received additional training data.

8. The method of claim 7, wherein the fine-tuning uses one of a supervised fine-tuning process or a low rank optimization process.

9. The method of claim 1, herein the computing device is a network-connected display device.

10. The method of claim 9, wherein the network-connected display device is a smart television.

11. A non-transitory computer-readable medium storing executable instructions that when executed by at least one processor of a network-connected display device cause the at least one processor to execute operations, the operations comprising:
executing a television application;
gathering information and data related to interactions of a user with a user interface of the television application;
storing the information and data related to the interactions of the user locally on the network-connected display device;
generating an on-device model associated with the user based on the information and data related to the interactions of the user with the user interface of the television application;
determining media content recommendations for the user utilizing the on-device model; and
integrating the media content recommendations in the user interface of the television application.

12. The non-transitory computer-readable medium of claim 11, wherein the on-device model is embedded on the network-connected display device.

13. The non-transitory computer-readable medium of claim 12, wherein the on-device model is a large language model.

14. The non-transitory computer-readable medium of claim 11, wherein the information and data associated with the user is not shared with any other computing devices.

15. The non-transitory computer-readable medium of claim 11, wherein the information and data include activities and interactions of the user with the television application.

16. The non-transitory computer-readable medium of claim 11, wherein the operations further comprise:
receiving additional training data; and
fine-tuning the on-device model based on the received additional training data.

17. The non-transitory computer-readable medium of claim 16, wherein the fine-tuning uses one of a supervised fine-tuning process or a low rank optimization process.

18. A system comprising:
at least one processor; and
a non-transitory computer-readable medium storing instructions that when executed by the at least one processor cause the system to:
execute a television application;
gather information and data related to interactions of a user with a user interface of the television application;
store the information and data related to the interactions of the user locally on the system;
generate an on-device model associated with the user based on the information and data related to the interactions of the user with the user interface of the television application;
determine media content recommendations for the user utilizing the on-device model; and
integrate the media content recommendations in a user interface of the television application.

19. The system of claim 18, wherein the on-device model is embedded on the system.

20. The system of claim 18, wherein the information and data associated with the user is not shared with any other systems.
